(19) United States
(12) Patent Application Publication
(10) Pub. No.: US 2001/0008403 A1
(43) Pub. Date: Jul. 19, 2001

(54) Method, computer and recording medium for controlling message display quantity in game software

(76) Inventor: Nobuhiro Komata, Tokyo (JP)

Correspondence Address: HELFGOTT & KARAS, P.C., 60th FLOOR, EMPIRE STATE BUILDING, NEW YORK, NY, 10118-0110, US

(21) Appl. No.: 09/757,807

(22) Filed: Jan. 10, 2001

(30) Foreign Application Priority Data
Jan. 14, 2000 (JP) 2000-40263

(51) Int. Cl. G09G 5/00

(52) U.S. Cl. 345/636

(57) ABSTRACT

In a method using a computer and a recording medium to make message display quantity in game software into an easy-to-use interface quantity of messages displayed on a screen of the computer by a controller which has a pressure sensing unit. An operation pressure of a user on the controller is detected by the pressure sensing unit and a pressure sensing output value that corresponds to the operation pressure is generated. The number of message display frames that corresponds to the pressure sensing output value is determined, and that number of message display frames are displayed on the screen or monitor all at once.

### FIELD OF THE INVENTION

This invention relates to a method for controlling message display quantity in game software, and a computer and recording medium used for it.

### BACKGROUND OF THE INVENTION

In role-playing games or simulation games and other computer games, it is common that conversations are exchanged between a player character operated by the player and counterpart characters in the game. Such conversation normally takes place in the form of messages displayed on the screen. Therefore if the messages are numerous, messages are displayed divided into several portions in times, rather than displaying all the message at once. The transition from one message to another takes place by pressing by a player of a specified button on the controller of the computer. This is a way to cope with the fact that different users read at different speeds.

A role-playing game is described in Japanese Patent No. 2794230.

Also, a love simulation game is described in Japanese unexamined Patent Laid-open Publication H9-192353 [1997].

Meanwhile, for computer input devices, mainly for the input devices of entertainment devices typified by game devices, there has been suggested the so-called pressure-sensitive controller. This pressure-sensitive controller outputs as a pressure sensing value the pressing force that results when a player applies pressure with his or her finger to an operation or control element of the controller that is connected to a pressure-sensitive element of the controller. As a specific example, a pressure-sensitive controller is disclosed in, for example, Japanese examined Utility Model Publication No. H1-40545 [1989], but here the pressure sensing output is input to a variable control oscillator (VCO), and the output of the VCO is used for rapid firing in games.

### SUMMARY OF THE INVENTION

It is an object of the present invention to make the display of messages by pressing a simple on-off switch on a controller into an interface that is easier to use.

This and other objects of the present invention are attained by a recording medium on which are recorded computer-readable and executable software programs that perform processing by taking as commands an output from a controller that has a pressure sensing means, and include processing programs that display messages on a screen of a computer in accordance with the output of the controller.

A method for controlling the message display quantity of the present invention comprises the steps of using a computer that includes a controller that has a pressure sensing means, detecting an operation pressure exerted by a user on said controller by said pressure sensing means, generating a pressure sensing output value that corresponds to said operation pressure, determining a number of message display frames that corresponds to said pressure sensing output value; and displaying said number of message display frames on a monitor of the computer all at once.

A computer of this invention comprises a controller which has a pressure sensing means that detects an operation pressure of a user on said controller; a means for generating pressure sensing output value that corresponds to the operation pressure detected by said pressure sensing means, a means for determining the number of message display frames in accordance with the pressure sensing output value, and a means that puts together the determined number of message display frames and displays them on the monitor by the computer.

### BRIEF DESCRIPTION OF THE DRAWINGS

FIG. 1 is a diagram showing a connection of a controller to an entertainment system to enable a user of the entertainment system to enjoy game software or images on the entertainment system;

FIGS. 2A-2C each show a scene in which, in a role-playing or simulation game, etc., the user is conversing with a character on the screen or monitor;

FIG. 3 is a table for selecting the number of frames per unit message display corresponding to each sensing value;

FIG. 4 is a table for associating each index number of each spoken line with a corresponding phrase;

FIG. 5 is a flowchart of a method by which phrases of sequential spoken lines are displayed at a speed that corresponds to the pressure sensing value;

FIG. 6 is a perspective view of the controller connected to the entertainment system;

FIG. 7 is a block diagram of the entertainment system;

FIG. 8 is a top plan view of the controller;

FIG. 9 is an exploded perspective of the second control part of the controller;

FIGS. 10A-10C are cross-sectional views of the second control part of FIG. 9;

FIG. 11 is a diagram showing the equivalent circuit of the pressure sensitive element;

FIG. 12 is a block diagram of the main parts of the controller.

FIG. 13 is an exploded perspective view of the first control part of the controller;

FIG. 14 is a cross-sectional view of the first control part of FIG. 13;

FIG. 15 is a diagram showing the circuit composition of the resistor;

FIG. 16 is a graph showing the characteristics of the output signal;

FIG. 17 is a block diagram showing the overall configuration, including the resistor; and

FIG. 18 is an exploded perspective view of the third control part of the controller.

### DETAILED DESCRIPTION OF THE PREFERRED

With a controller that has pressure-sensitive elements, when a button, which is an operation element, is pressed by a user or player in the entertainment system, the controller not only detects the presence or absence of its pressure sensing output, for example, whether the switch is on or off, but also obtains a pressure sensing value output in accordance with the pressing force of the user exerted on the control element. Meanwhile, in software or a game that makes use of a pressure sensing value output, processing or action can be decided upon in correspondence with the pressure sensing value output. This embodiment has been made in such a way that even if, for example, messages are displayed on the screen according to operation of the operation elements, the message display is changed at a speed that corresponds to the pressure sensing value due to the pressing operation of each operation element by the user.

In this embodiment, messages are displayed at a speed that corresponds to the pressure sensing value output when one operates a controller that has a pressure sensitive element. This provides a system with a better user interface than one in which the on operation of a simple on-off switch is repeated or continued.

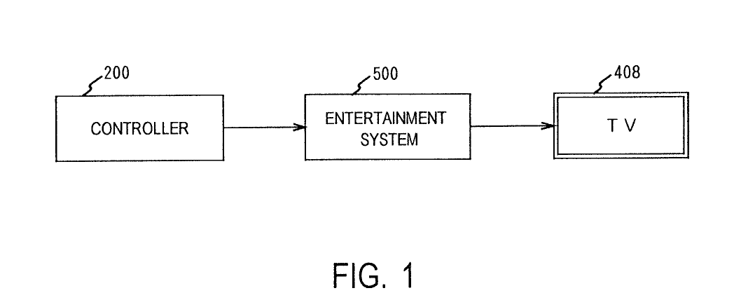

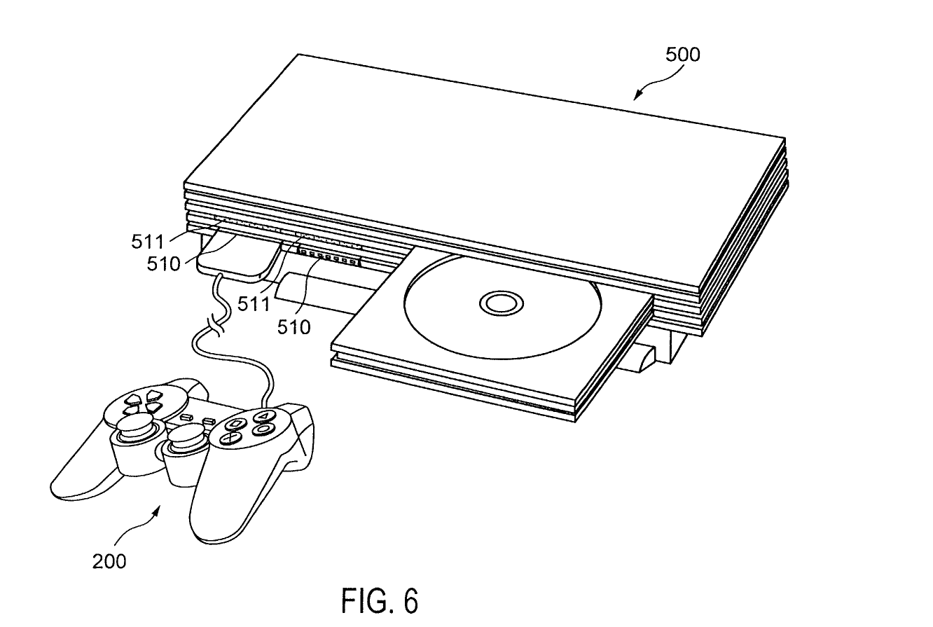

FIG. 1 shows a connection of a computer to the entertainment system for enjoying game software or images by a user using the entertainment system 500. A more specific structure is shown in FIG. 6 and other figures.

As shown in FIG. 1, controller 200, which has buttons connected to pressure sensitive elements, is connected to entertainment system 500 for playing games or enjoying the images on a DVD video, etc., and the image output terminal of the entertainment system is connected to a television monitor 408. Here, the analog output from the pressure sensitive elements is converted to digital values from 0 to 255 by an analog-to-digital converter and is supplied to entertainment system 500.

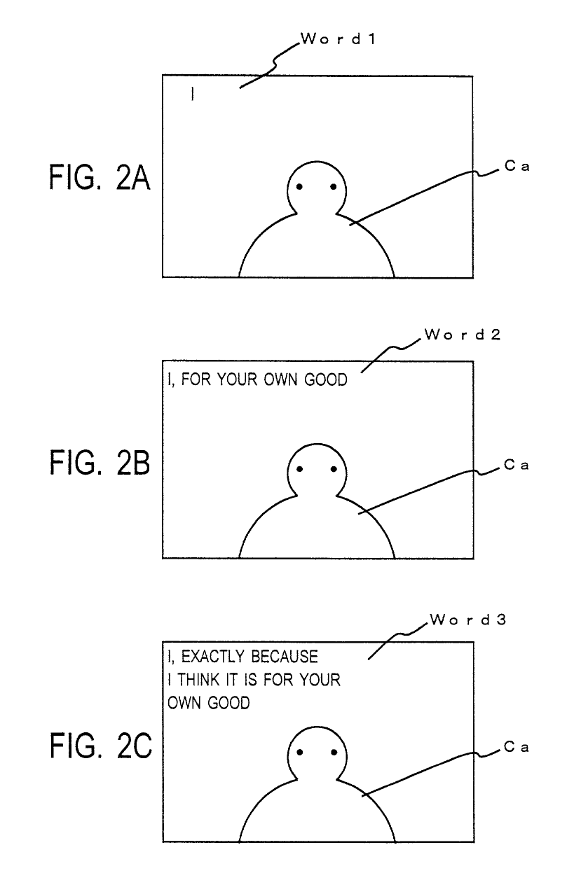

In the following, we describe, with reference to FIGS. 2-5, the case in which messages are displayed by operation of controller 200. As shown in FIG. 2, one or multiple phrases that comprise a single spoken line are displayed in order one at a time. FIG. 2 shows a scene in which, in a role-playing game (RPG) or simulation game, etc., a character on the screen and the user engage in a dialog.

For example, if the entirety of one spoken line from character Ca is “I am giving you a warning exactly because I think it is for your own good.”, first, “I” is displayed as shown in FIG. 2A, then “for your own good” is added and “I, for your own good” is displayed as shown in FIG. 2B, then “exactly because I think it is” is added and “I, exactly because I think it is for your own good” is displayed as shown in FIG. 2C.

For example, in order to display messages in games, etc. heretofore, a method has been adopted in which a message is displayed one line at a time or several lines at a time by repeatedly pressing an on-off switch. With this method it is necessary to repeatedly press a button as many times as the number of lines that contain that message predetermined by the program.

In this embodiment, this is done in such a way that the phrases that comprise a spoken line are displayed in order automatically at a speed that corresponds to the size of the pressure sensing value from a pressure-sensitive controller.

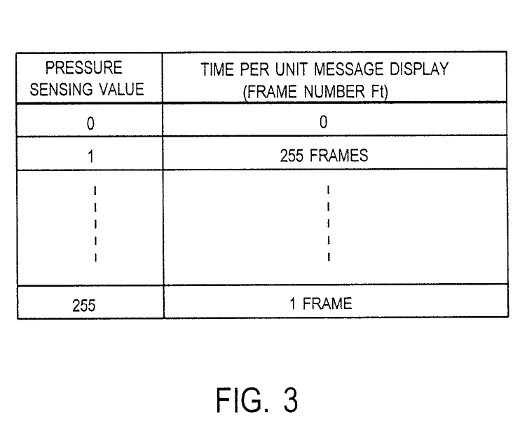

Shown in FIG. 3 is a table for selecting the time, that is, the number Ft of frames, per unit message display corresponding to each pressure sensing value from 0 to 255. Here, if the pressure sensing value is “0”, the number Ft of unit message display frames is “0 frames”, if the pressure sensing value is “1”, the number Ft of unit message display frames is “255 frames”,. . . , and if the pressure sensing value is “255”, the number Ft of unit message display frames is “1 frame”. Also, this conversion table between pressure sensing values and numbers of unit message display frames is an illustrative example; one could of course adopt another conversion table so that, for example, as the pressure sensing value gets larger, the number of unit message display frames gets smaller.

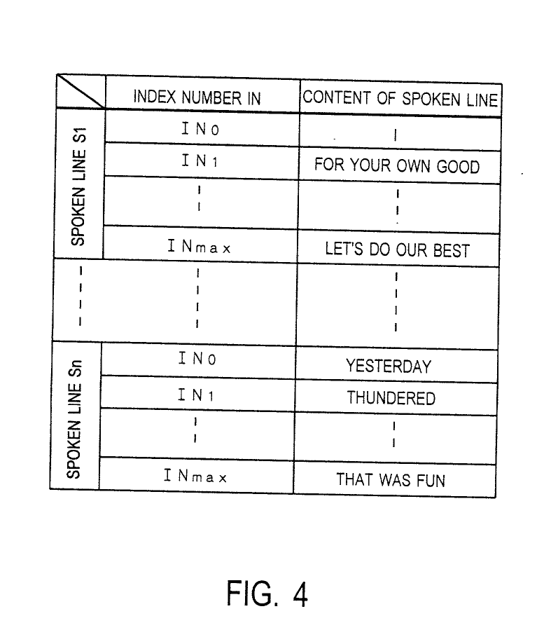

Shown in FIG. 4 is a table for making the correspondence between each index number IN0 to INₘₐₓ of each spoken line S1-Sn and each corresponding phrase of the spoken line, such as “I”, “try my best”, “yesterday”, “it was fun”.

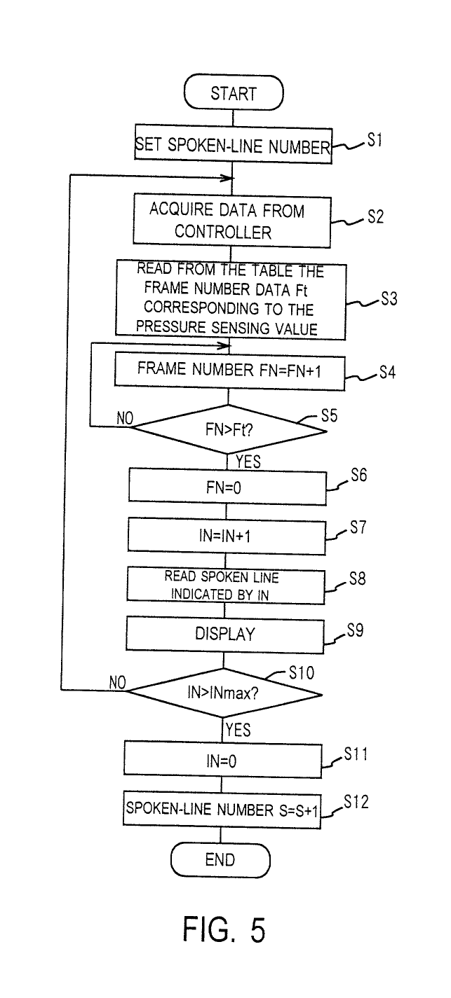

Referring view to FIG. 5 a method by which spoken-line phrases are displayed in sequence at a speed corresponding to the pressure sensing value will be now described. The flowchart of FIG. 5 shows the processing by the program for spoken-line display.

In FIG. 5, in step S1, the spoken-line number is set. This is the initialization.

In step S2, the pressure sensing value is acquired, then processing proceeds to step S3, references the table shown in FIG. 3, and reads the frame number data Ft that corresponds to the pressure sensing value.

In step S4, one adds 1 to the frame number FN, and in step S5, it is determined whether frame number FN is greater than the frame number Ft read from the table; if “YES”, processing proceeds to step S6, and if “NO”, processing returns to step S4.

This step S4 processing means that the frame number FN for counting is incremented until it reaches the frame number Ft read from the table. One increment is done, for example, every frame. During this time the image stored in the video memory of entertainment system 500 continues to be output. That is, the same spoken line continues to be displayed.

In step S6, frame number FN is set to 0, and in step S7, 1 is added to the index number IN that indicates the phrase.

In step S8, all the phrase data items corresponding to all the index numbers IN from the current index number IN are read from the table shown in FIG. 4. The meaning of this is explained by referring to FIGS. 2 and 4 as examples. For example, when spoken line S1 is set, if the index number IN after addition is IN2, then the index numbers used until then are IN0 and IN1. Thus the image being displayed at the present time is as in FIG. 2B.

Then, because index number IN is IN2, all the phrases that correspond to index numbers IN0 and IN1 thus far and to post-increment index number IN2 are read from the table shown in FIG. 4.

In this example, the image data corresponding to the text data indicating, respectively, “I” for index number IN0, “for your own good” for index number IN1, and “exactly because I think it is” for index number IN2 is read and is written into the video memory. Thus an image as shown in FIG. 2C is output.

As is clear from the above explanation, when the value of a new index number IN is determined, the phrase indicated by this value, as well as all the phrases thus far, are read again.

In step S9, the prescribed location of the video memory, that is, the images showing the phrases indicated by all the index numbers IN read in step S8 are read in together with the character images. In this way, an updated image is displayed on television monitor 408.

In step S10, it is determined whether index number IN is greater than the value of maximum value INₘₐₓ; if “YES”, processing proceeds to step S11 and it is initialized by index number IN being set to 0, and if “NO”, processing returns to step S2.

In step S12, 1 is added to spoken-line number S. This is set in order to be ready for the spoken line to be used in the next scene.

As explained above, in this embodiment, the display of one or multiple phrases is done at a speed that corresponds to the pressure sensing value from the controller pressed by the user, which makes it possible to realize an entertainment system with a better user interface than by selection by simple on-off switches.

In the above example, the explanation concerned a case in which phrases are added little by little, but one may also add them a line of text at a time or multiple lines of text at a time. And in displaying new phrases or lines of text, one may do it in such a way as not to display the previous phrases or lines.

Also, one may determine the rate of change from the previous pressure sensing value and the current pressure sensing value and display phrases and lines of text every number of frames in accordance with this rate of change. For example, if the previous-time pressure sensing value is 100 and the current pressure sensing value is 50, the rate of change is 50%, so one may set the number of frames to double the previous number of frames.

Also, in the reverse of the table shown in FIG. 3, one may have a table in which large frame numbers are associated with low pressure sensing values, so that the higher the pressure sensing value, the longer the time until a new phrase is displayed.

An embodiment of this invention that is applied to a controller of a video game system that is an example of a computer is explained below.

FIG. 6 is a perspective view showing the controller 200 connected to entertainment system 500. The controller 200 is removably connected to the entertainment system 500, and the entertainment system 500 is connected to television monitor 408.

The entertainment system 500 reads the program for a computer game from recording media upon which that program is recorded and by executing the program, displays characters on the television monitor 408. The entertainment system 500 has various built-in functions for DVD (Digital Versatile Disc) playback, CDDA (compact disc digital audio) playback and the like. The signals from the controller 200 are also processed as one of the aforementioned control functions within the entertainment system 500, and the content thereof may be reflected in the movement of characters and the like, on the television monitor 408.

While this depends also on the content of the computer game program, controller 200 may be allocated functions for moving the characters displayed on the television monitor 408 in the directions up, down, left or right.

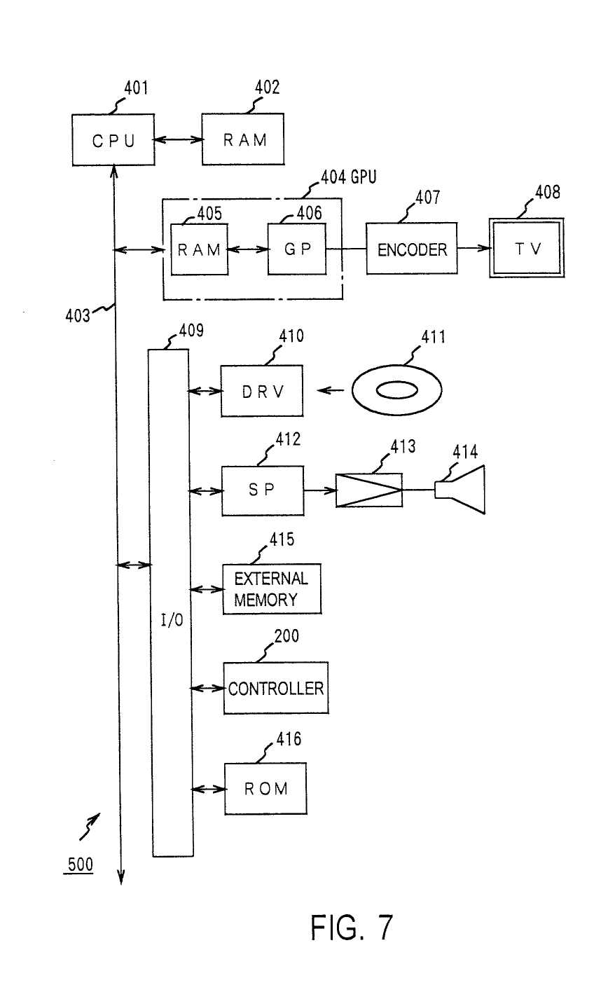

With reference to FIG. 7, here follows a description of the interior of the entertainment system 500 shown in FIG. 6. FIG. 7 is a block diagram of the entertainment system 500.

A CPU 401 is connected to RAM 402 and a bus 403, respectively. Connected to bus 403 are a graphics processor unit (GPU) 404 and an input/output processor (I/O) 409, respectively. The GPU 404 is connected via an encoder 407 for converting a digital RGB signal or the like into the NTSC standard television format, for example, to a television monitor (TV) 408 as a peripheral. Connected to the I/O 409 are a driver (DRV) 410 used for the playback and decoding of data recorded upon an optical disc 411, a sound processor (SP) 412, an external memory 415 consisting of flash memory, controller 200 and a ROM 416 which records the operating system and the like. The SP 412 is connected via an amplifier 413 to a speaker 414 as a peripheral.

Here, the external memory 415 may be a card-type memory consisting of a CPU or a gate array and flash memory, which is removably connected via a connector 511 to the entertainment system 500 shown in FIG. 6. The controller 200 is configured such that, when a plurality of buttons provided thereupon are pushed, it gives instructions to the entertainment system 500. In addition, the driver 410 is provided with a decoder for decoding images encoded based upon the MPEG standard.

The description will be made now as to how the images will be displayed on the television monitor 408 based on the operation of controller 200. It is assumed that data for objects consisting of polygon vertex data, texture data and the like recorded on the optical disc 411 is read by the driver 410 and stored in the RAM 402 of the CPU 401.

When instructions from the player via controller 200 are provided as an input to the entertainment system 500, the CPU 401 calculates the three-dimensional position and orientation of objects with respect to the point of view based on these instructions. Thereby, the polygon vertex data for objects defined by X,Y, Z coordinate values are modified variously. The modified polygon vertex data is subjected to perspective conversion processing and converted into two-dimensional coordinate data.

The regions specified by two-dimensional coordinates are so-called polygons.

The converted coordinate data, Z data and texture data are supplied to the GPU 404. Based on this converted coordinate data and Z data, the GPU 404 performs the drawing process by writing texture data sequentially into the Ram 405. One frame of image data upon which the drawing process is completed, is encoded by the encoder 407 and then supplied to the television monitor 408 and displayed on its screen as an image.

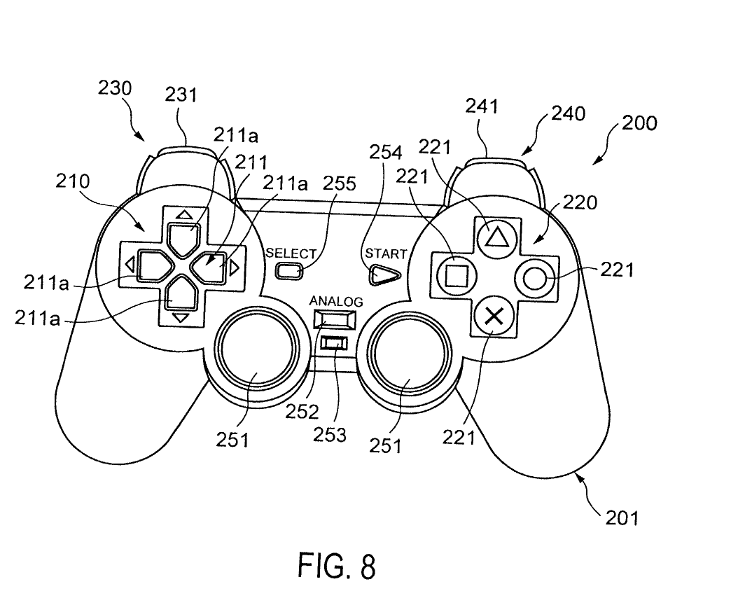

FIG. 8 is a top view of controller 200.

The controller 200 consists of a unit body 201 on the top surface of which are provided first and second control parts 210 and 220, and on the side surface of which are provided third and fourth control parts 230 and 240 of the controller 200.

The first control part 210 of the controller is provided with a cruciform control unit 211 used for pushing control, and the individual control keys 211 a extending in each of the four directions of the control unit 211 form a control element. The first control part 210 is the control part for providing movement to the characters displayed on the screen of the television receiver, and has the functions for moving the characters in the up, down, left and right directions by pressing the individual control keys 211a of the cruciform control unit 211.

The second control part 220 is provided with four cylindrical control buttons 221 (control elements) for pushing control. The individual control buttons 221 have identifying marks such as ∘ (circle), Δ (triangle), □ (quadrangle), and × (cross) on their tops, in order to easily identify the individual control buttons 221. The functions of the second control part 220 are set by the game program recorded upon the optical disc 411, and the individual control buttons 221 may be allocated functions that change the state of the game characters, for example. For example, the control buttons 221 may be allocated functions for moving the left arm, right arm, left leg and right leg of the character.

The third and fourth control parts 230 and 240 of the controller have nearly the same structure, and both are provided with two control buttons 231 and 241 (control elements) for pushing control, arranged above and below. The functions of these third and fourth control parts 230 and 240 are also set by the game program recorded upon the optical disc, and may be allocated functions for making the game characters do special actions, for example.

Moreover, two joy sticks 251 for performing analog operation are provided upon the unit body 201 shown in FIG. 8. The joy sticks 251 can be switched and used instead of the first and second control parts 210 and 220 described above. This switching is performed by means of an analog selection switch 252 provided upon the unit body 201. When the joy sticks 251 are selected, a display lamp 253 provided on the unit body 201 lights, indicating the state wherein the joy sticks 251 are selected.

It is to be noted that on unit body 201 there are also provided a start switch 254 for starting the game and a select switch 255 for selecting the degree of difficulty or the like at the start of a game, and the like.

Controller 200 is held by the left hand and the right hand of the user and is operated by the other user's fingers, and in particular the user's thumbs are able to operate most of the buttons on the top surface.

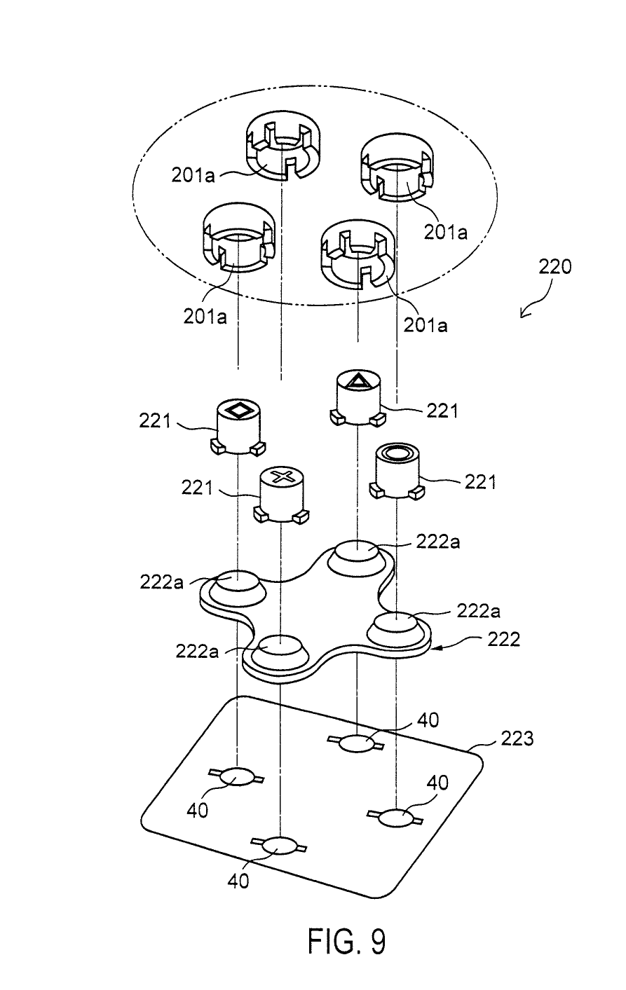

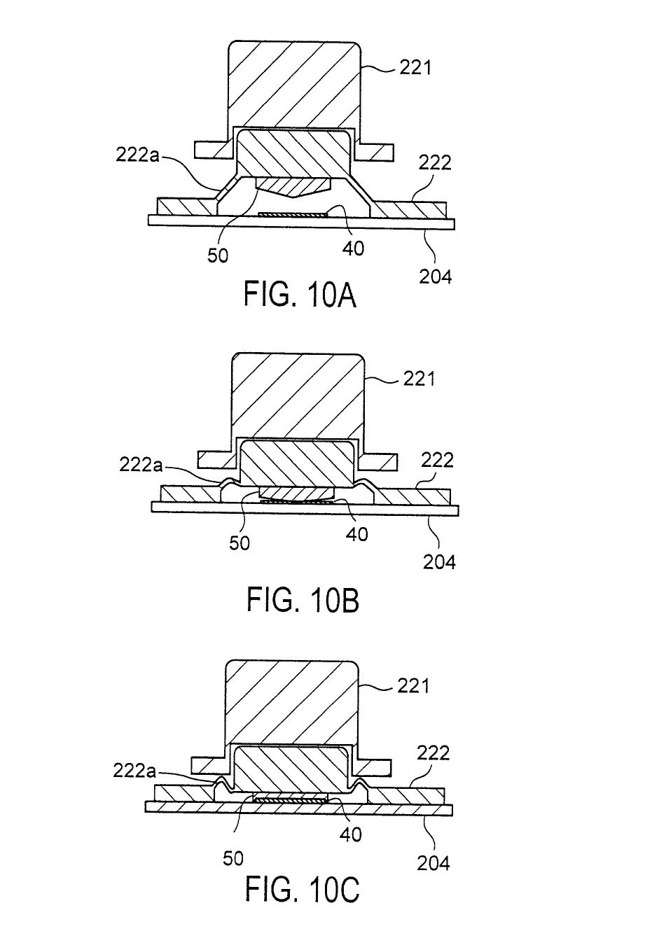

FIG. 9 and FIGS. 10A-10C are, respectively, an exploded respective view and cross-sectional views showing the second control part of the controller.

As shown in FIG. 9, the second control part 220 consists of four control buttons 221 which serve as the control elements, an elastic body 222, and a sheet member 223 provided with resistors 40. The individual control buttons 221 are inserted from behind through insertion holes 201 a formed on the upper surface of the unit body 201. The control buttons 221 inserted into the insertion holes 201a are able to move freely in the axial direction.

The elastic body 222 is made of insulating rubber or the like and has elastic areas 222a which protrude upward, and the lower ends of the control buttons 221 are supported upon the upper walls of the elastic areas 222a. When the control buttons 221 are pressed, the inclined-surface portions of these elastic areas 222a flex so that the upper walls move together with the control buttons 221. On the other hand, when the pushing pressure on the control buttons 221 is released, the flexed inclined-surface portions of elastic areas 222a elastically return to their original shape, pushing up the control buttons 221. The elastic body 222 functions as a spring means whereby control buttons 221 which had been pushed in by a pushing action are returned to their original positions. As shown in FIGS. 10A-10C, conducting members 50 are attached to the rear surface of the elastic body 222.

The sheet member 223 consists of a membrane or other thin sheet material which has flexibility and insulating properties. Resistors 40 are provided in appropriate locations on this sheet member 223 and these resistors 40 and conducting member 50 are each disposed such that they face one of the control buttons 221 via the elastic body 222. The resistors 40 and conducting members 50 form pressure-sensitive devices. These pressure-sensitive devices consisting of resistors 40 and conducting members 50 have resistance values that vary depending on the pushing pressure received form the control buttons 221.

To describe this in more detail, as shown in FIGS. 10A-10C, the second control part 220 is provided with control buttons 221 as control elements, an elastic body 222, conducting members 50 and resistors 40. Each conducting member 50 may be made of conductive rubber which has elasticity, for example, and has a conical shape with its center as a vertex. The conducting members 50 are adhered to the inside of the top surface of the elastic areas 222a formed in the elastic body 222.

In addition, the resistors 40 may be provided on an internal board 204, for example, opposite the conducting members 50, so that the conducting members 50 come into contact with resistors 40 together with the pushing action of the control buttons 221. The conducting member 50 deforms, depending on the pushing force on the control button 221 (namely the contact pressure with the resistor 40), so as shown in FIGS. 10B and 10C the surface area in contact with the resistor 40 varies depending on the pressure. To wit, when the pressing force on the control button 221 is weak, as shown in FIG. 10B, only the area near the conical tip of the conducting member 50 is in contact. As the pressing force on the control button 221 becomes stronger, the tip of the conducting member 50 deforms gradually so the surface area in contact expands.

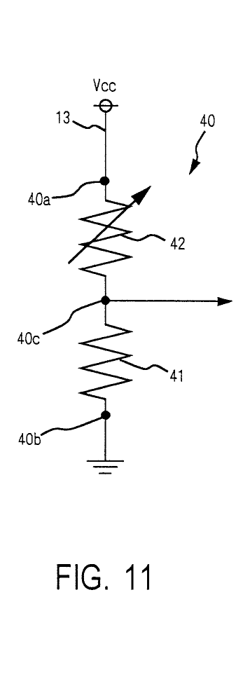

FIG. 11 is a diagram showing an equivalent circuit for a pressure-sensitive device consisting of a resistor 40 and conducting member 50. As shown in this diagram, the pressure-sensitive device is inserted in series in a power supply line 13, where the voltage Vcc applied between the electrodes 40a and 40b. As shown in this diagram, the pressure-sensitive device is divided into a variable resistor 42 that has the relatively small resistance value of the conducting member 50, and a fixed resistor 41 that has the relatively large resistance value of the resistor 40. Among these, the portion of the variable resistor 42 is equivalent to the portion of resistance in the contact between the resistor 40 and the conducting member 50, so the resistance value of the pressure-sensitive device varies depending on the surface area of contact with the conducting member 50.

When the conducting member 50 comes into contact with the resistor 40, in the portion of contact, the conducting member 50 becomes a bridge instead of the resistor 40 and a current flows, so the resistance value becomes smaller in the portion of contact. Therefore, the greater the surface area of contact between the resistor 40 and conducting member 50, the lower the resistance value of the pressure-sensitive device becomes. In this manner, the entire pressure-sensitive device can be understood to be a variable resistor. It is noted that FIGS. 10A-10C show only the contact portion between the conducting member 50 and resistor 40 which forms the variable resistor 42 of FIG. 11, but the fixed resistor 41 of FIG. 11 is omitted from FIGS. 10A-10C.

In the preferred embodiment, an output terminal is provided near the boundary between the variable resistor 42 and fixed resistor 41, namely near the intermediate point of the resistors 40, and thus a voltage stepped down from the applied voltage V_{cc} by the amount the variable resistance is extracted as an analog signal corresponding to the pushing pressure by the user on the control button 221.

First, since a voltage is applied to the resistor 40 when the power is turned on, even if the control button 221 is not pressed, a fixed analog signal (voltage) Vₘᵢₙ is provided as the output from the output terminal 40c. Next, even if the control button 221 is pressed, the resistance value of this resistor 40 does not change until the conducting member 50 contacts the resistor 40, so the output from the resistor 40 remains unchanged at Vₘᵢₙ. If the control button 221 is pushed further and the conducting member 50 comes into contact with the resistor 40, the surface area of contact between the conducting member 50 and the resistor 40 increases in response to the pushing pressure on the control button 221, and thus the resistance of the resistor 40 is reduced so the analog signal (voltage) output from the output terminal 40c of the resistor 40 increases. Furthermore, the analog signal (voltage) output form the output terminal 40c of the resistor 40 reaches the maximum Vₘₐₓ when the conducting member 50 is most deformed.

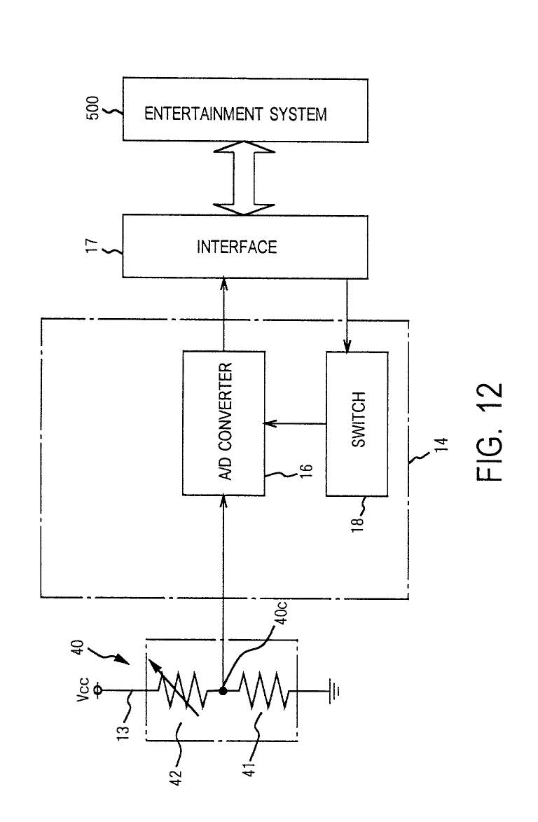

FIG. 12 is a block diagram showing the main parts of the controller 200.

An MPU 14 mounted on the internal board of the controller 200 is provided with a switch 18 and an A/D converter 16. The analog signal (voltage) output from the output terminal 40c of the resistor 40 is provided as the input to the A/D converter 16 and is converted to a digital signal.

The digital signal output from the A/D converter 16 is sent via an interface 17 provided upon the internal board of the controller 200 to the entertainment system 500 and the actions of game characters and the like are executed based on this digital signal.

Changes in the level of the analog signal output from the output terminal 40c of the resistor 40 correspond to changes in the pushing pressure received form the control button 221 (control element) as described above. Therefore, the digital signal outputted from the A/D converter 16 corresponds to the pushing pressure on the control button 221 (control element) from the user. If the actions of the game characters and the like are controlled based on the digital signal that has such a relationship with the pushing pressure from the user, it is possible to achieve smoother and more analog-like action than with control based on a binary digital signal based only on zeroes and ones.

The configuration is such that the switch 18 is controlled by a control signal sent from the entertainment system 500 based on a game program recorded on an optical disc 411. When a game program recorded on optical disc is executed by the entertainment system 500, depending on the content of the game program, a control signal is provided as output to specify whether the A/D converter 16 is to function as a means of providing output of a multi-valued analog signal, or as a means of providing a binary digital signal. Based on this control signal, the switch 18 is switched to select the function of the A/D converter 16.

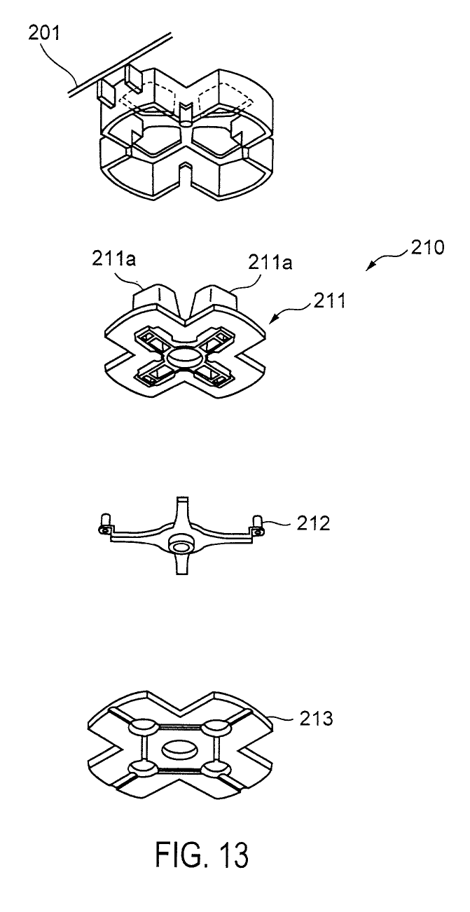

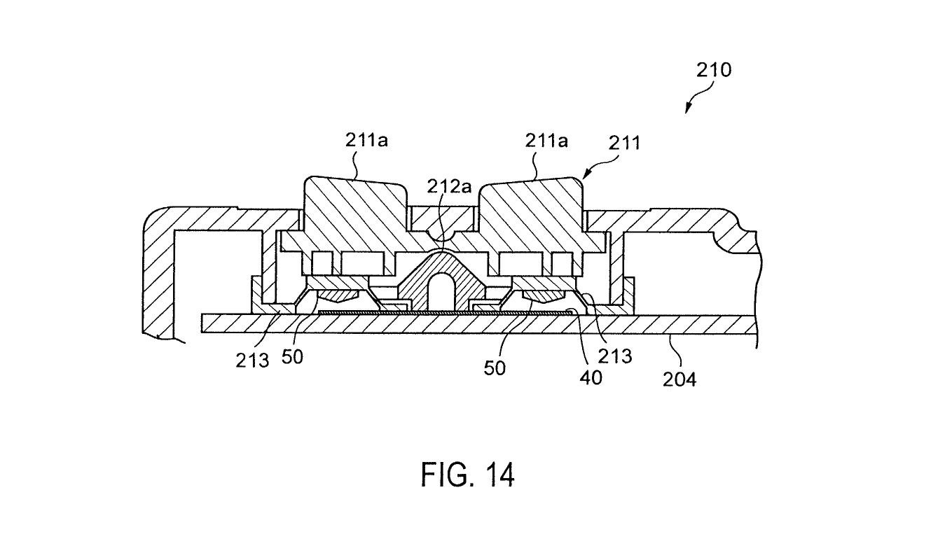

FIGS. 13 and 14 show an embodiment of the configuration of the first control part of the controller.

As shown in FIG. 13, the first control part 210 includes a cruciform control unit 211, a spacer 212 that positions this control unit 211, and an elastic body 213 that elastically supports the control unit 211. Moreover, as shown in FIG. 14, a conducting member 50 is attached to the rear surface of the elastic body 213, and the configuration is such that resistors 40 are disposed at the positions facing the individual control keys 211 a (control elements) of the control unit 211 via the elastic body 213.

The overall structure of the first control part 210 has already been made public knowledge in the publication of unexamined Japanese patent application No. JP-A-H8-163672. The control unit 211, however, uses a hemispherical projection 212a formed in the center of the spacer 212 as a fulcrum, and the individual control keys 211 a (control elements) are assembled such that they can push on the resistor 40 side (see FIG. 14).

Conducting members 50 are adhered to the inside of the top surface of the elastic body 213 in positions corresponding to the individual control keys 211a (control elements) of the cruciform control unit 211. In addition, the resistors 40 with a single structure are disposed such that they face the individual conducting members 50.

When the individual control keys 21 la which are control elements are pushed, the pushing pressure acts via the elastic body 213 on the pressure-sensitive devices consisting of a conducting member 50 and resistor 40, so that its electrical resistance value varies depending on the magnitude of the pushing pressure.

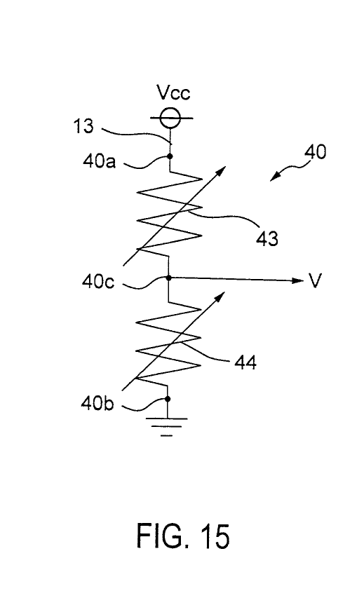

FIG. 15 is a diagram showing the circuit configuration of the resistor. As shown in this diagram, the resistor 40 is inserted in series in a power supply line 13, where a voltage is applied between the electrodes 40a and 40b. The resistance of this resistor 40 is illustrated schematically, as shown in this diagram; the resistor 40 is divided into first and second variable resistors 43 and 44. Among these, the portion of the first variable resistor 43 is in contact, respectively, with the conducting member 50 that moves together with the control key (up directional key) 211a for moving the character in the up direction, and with the conducting member 50 that moves together with the control key (left directional key) 211a for moving the character in the left direction, so its resistance value varies depending on the surface area in contact with these conducting members 50.

In addition, the portion of the second variable resistor 44 is in contact, respectively, with the conducting member 50 that moves together with the control key (down directional key) 21 la for moving the character in the down direction, and with the conducting member 50 that moves together with the control key (right directional Key) 211a for moving the character in the right direction, so its resistance value varies depending on the surface area in contact with these conducting members 50.

Moreover, an output terminal 40c is provided intermediate between the variable resistors 43 and 44, and an analog signal corresponding to the pushing pressure on the individual control keys 211a (control elements) is providing as output from this output terminal 40c.

The output from the output terminal 40c can be calculated from the ratio of the split in resistance value of the first and second variable resistors 43 and 44. For example, if R1 is the resistance value of the first variable resistor 43, R2 is the resistance value of the second variable resistor 44 and V_{cc} is the power supply voltage, then the output voltage V appearing at the output terminal 40c can be expressed by the following equation.

V=V_{cc}×R2/(R1+R2)

Therefore, when the resistance value of the first variable resistor 43 decreases, the output voltage increases, but when the resistance value of the second variable resistor 44 decreases, the output voltage also decreases.

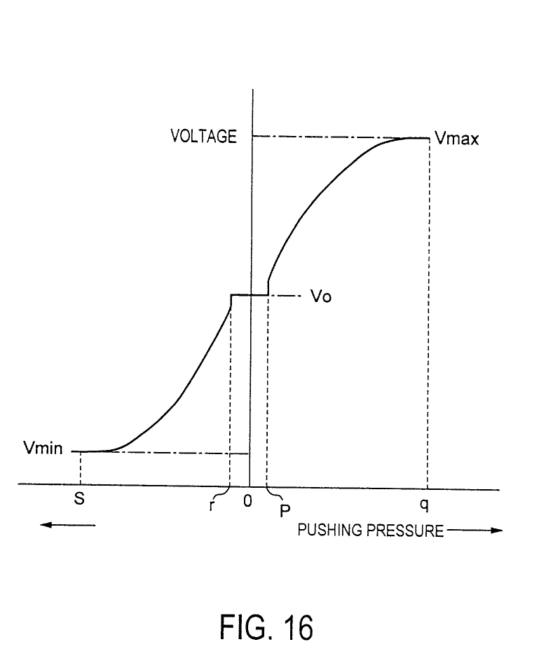

FIG. 16 is a graph showing the characteristic of the analog signal (voltage) outputted from the output terminal of the resistor.

First, since a voltage is applied to the resistor 40 when the power is turned on, even if the individual control keys 211a of the control unit 211 are not pressed, a fixed analog signal (voltage) V₀ is provided as output form the output terminal 40c (at position 0 in the graph).

Next, even if one of the individual control keys 221a is pressed, the resistance value of this resistor 40 does not change until the conducting member 50 contacts the resistor 40, and the output from the resistor 40 remains unchanged at V₀.

Furthermore, if the up-directional key or left-directional key is pushed until the conducting member 50 comes into contact with the first variable resistor 43 portion of the resistor 40 (at position p in the graph), thereafter the surfaced area of contact between the conducting member 50 and the first variable resistor 43 portion increases in response to the pushing pressure on the control key 221a (control element), and thus the resistance of that portion is reduced so the analog signal (voltage) output from the output terminal 40c of the resistor 40 increases. Furthermore, the analog signal (voltage) output form the output terminal 40c of the resistor 40 reaches the maximum Vₘₐₓ when the conducting member 50 is most deformed (at position q in the graph).

On the other hand, if the down-directional key or right-directional key is pushed until the conducting member 50 comes into contact with the second variable resistor 44 portion of the resistor 40 (at position r in the graph), thereafter the surface area of contact between the conducting member 50 and the second variable resistor 44 portion increases in response to the pushing pressure on the control key 211a (control elements), and thus the resistance of that portion is reduced, and as a result, the analog signal (voltage) output from the output terminal 40c of the resistor 40 decreases. Furthermore, the analog signal (voltage) output form the output terminal 40c of the resistor 40 reaches the minimum Vₘᵢₙ when the conducting member 50 is most deformed (at position s in the graph).

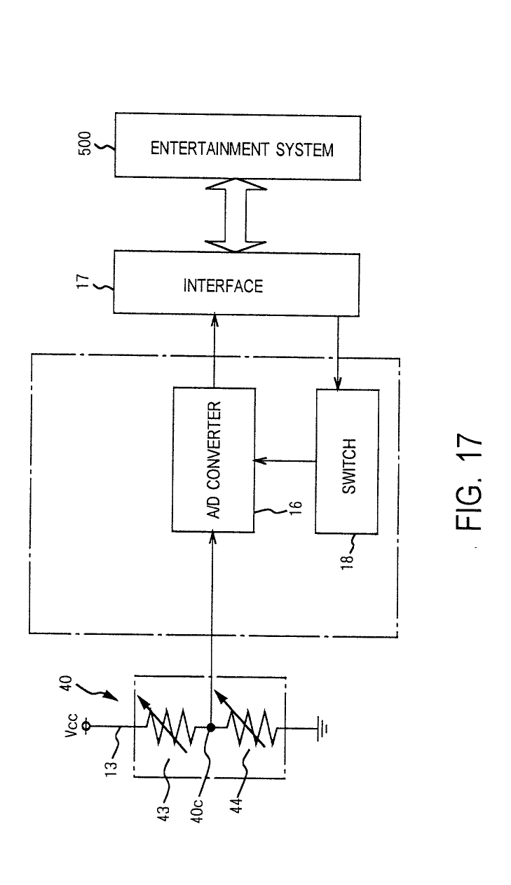

As shown in FIG. 17, the analog signal (voltage) output from the output terminal 40c of the resistor 40 is provided as input to an A/D converter 16 and converted to a digital signal. Note that the function of the A/D converter 16 is shown in FIG. 17 is as described previously based on FIG. 12, so a detailed description shall be omitted here.

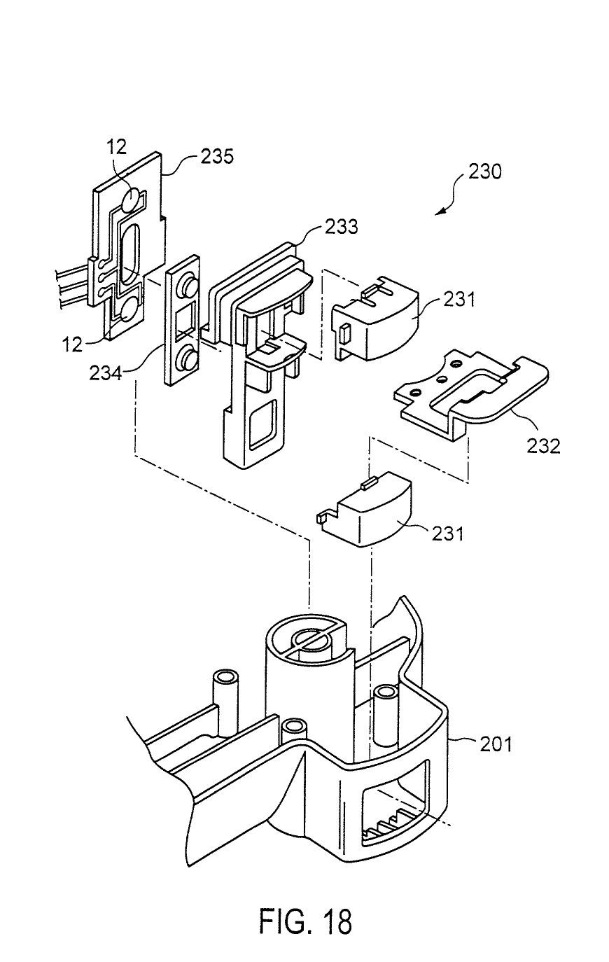

FIG. 18 is an exploded perspective view of the third control part of the controller.

The third control part 230 consists of two control buttons 231, a spacer 232 for positioning these control buttons 231 within the interior of the controller 200, a holder 233 that supports these control buttons 231, an elastic body 234 and an internal board 235, having a structure wherein resistors 40 are attached to appropriate locations upon the internal board 235 and conducting members 50 are attached to the rear surface of the elastic body 234.

The overall structure of the third control part 230 also already has been made public knowledge in the publication of unexamined Japanese patent application No. JP-A-H8-163672, so a detailed description thereof will be omitted. The individual control buttons 231 can be pushed in while being guided by the spacer 232, the pushing pressure when pressed acts via the elastic body 234 on the pressure-sensitive device consisting of a conducting member 50 and resistor 40. The electrical resistance value of the pressure-sensitive device varies depending on the magnitude of the pushing pressure it receives.

It is noted that the fourth control part 240 has the same structure as that of the third control part 230 described above.

In the above description, a flowchart for displaying spoken lines is shown in FIG. 5. This program can be provided either in a form recorded individually on a recording medium such as an optical disk, or in a form recorded on said recording medium together with game software as part of the game software.

This program is activated on entertainment system 500 and executed on its CPU. Here, the significance of the spoken-line display program being provided recorded individually on a recording medium is that it is made available previously as a library for software development.

As is well known, in developing software it takes an enormous amount of time to write all the functions.

But if the software functions are broken up into single functions, then many functions will be included that are used in common by various software, such as the function of causing objects to move.

Thus functions that can be used in common such as this embodiment can be provided to software manufacturers as library programs. By having others provide such common functions as programs for generalized functions, software manufacturers can concentrate on just producing the essential part of their software.

In the foregoing, only one embodiment has been described alternative embodiments can also be suggested in this invention. In the described embodiment the pressure sensing value pressed by the user is used as is. But in order to compensate for differences in users' physical strength or nervous reactions, the maximum value of a user's pressure sensing value can be corrected to the maximum game pressure sensing value set by the program, with intermediate values corrected proportionately. Such compensation is done by preparing a compensation table. Also, a user's pressure sensing value can be corrected by a well known function and used as the game pressure sensing value. In addition, the maximum value of a user's pressure sensing value rate of change can be corrected to a program-set maximum game pressure sensing value rate of change, with intermediate values corrected proportionately. For these specific techniques, see the present inventors' Japanese patent application H2000-40257 and the corresponding PCT/JP /(Applicant's file reference No. SC0097WO00).

With this invention, the display of messages by pressing simple on-off switches on a controller can be made into an interface that is easier to use.

Also, with this invention, one or multiple phrases are displayed at a speed that corresponds to the pressure sensing value from a controller pressed by the user, which makes it possible to realize an entertainment system with a better user interface than by selection by simple on-off switches.

1. A recording medium on which are recorded computer-readable and executable software programs that perform processing by taking as commands an output from a controller which has a pressure sensing means, wherein
said software programs include processing programs that display messages on a screen of a computer in accordance with the output of said controller.

2. The recording medium as described in claim 1, wherein
messages are displayed in accordance with the rate of change per unit time of an output value of said controller.

3. The recording medium as described in claim 1, wherein
messages are displayed in accordance with the speed that corresponds to the magnitude of an output value of said controller.

4. A method for controlling display quantity of messages, using a computer that has a controller including a pressure sensing means, the method comprising the steps of:
detecting an operation pressure of a user on said controller by said pressure sensing means;
generating a pressure sensing output value in dependence on said operation pressure;
determining a number of message display frames, that corresponds to said pressure sensing output value;
displaying said number of message display frames on a monitor of a computer all at once.

5. The method as described in claim 4, wherein
said determining step messages are displayed in accordance with the rate of change per unit time of said pressure sensing output value.

6. The method as described in claim 4, wherein
said determining step messages are displayed in accordance with the speed that corresponds to the size of said pressure sensing output value.

7. The method as described in claim 4, wherein said determining in which in the stage in step the number of message display frames is determined in accordance with said pressure sensing output value by using a correspondence table.

8. The method as described in claim 4, wherein
said determining step the rate of change is determined from previous pressure sensing value and a current pressure sensing value and the number of message display frames is determined in accordance with said rate of change.

9. A computer having a pressure sensing means that detects an operation pressure of a user on the controller; the computer comprising:
a means for generating a pressure sensing output value that corresponds to the operation pressure detected by said pressure sensing means,
a means for determining a number of message display frames in accordance with said pressure sensing output value; and
a means for putting together said determined number of message display frames and displaying said message display frames on a monitor of the computer.

10. The computer as described in claim 9, wherein
said determining means displays messages in accordance with the rate of change per unit time of said pressure sensing output value.

11. The computer as described in claim 10, wherein
said determining means displays messages in accordance with a speed corresponding to the magnitude of said pressure sensing output value.

12. The computer as described in claim 10, wherein
said determining means determines a number of message display frames according said pressure sensing output value by using a conversion table.

13. The computer as described in claim 10, wherein
said determining means determines the rate of change of a current pressure sensing value from a previous pressure sensing value and determines the number of message display frames in accordance with said rate of change.
